(19) United States
(12) Patent Application Publication
(10) Pub. No.: US 2018/0330350 A1
(43) Pub. Date: Nov. 15, 2018

(54) AUTOMATED TRANSACTION APPARATUS AND AUTOMATED TRANSACTION METHOD

(71) Applicant: FUJITSU FRONTECH LIMITED, Tokyo (JP)

(72) Inventor: Satoshi Mukogawa, Inagi (JP)

(73) Assignee: FUJITSU FRONTECH LIMITED, Tokyo (JP)

(21) Appl. No.: 16/044,017

(22) Filed: Jul. 24, 2018

Related U.S. Application Data
(63) Continuation of application No. PCT/JP2016/054916, filed on Feb. 19, 2016.

(51) Int. Cl. G06Q 20/10; G07F 19/00

(52) U.S. Cl. CPC G06Q 20/1085; G07F 19/205

(57) ABSTRACT

When a card insertion detecting unit detects insertion of a card, a display control unit causes an aerial display to appear in mid-air and displays a transaction procedure for a card transaction. When a customer performs an operation in accordance with the transaction procedure, a card transaction processing unit performs card transaction processing, after which the aerial display is set in a non-display state. When a mobile terminal detecting unit detects a mobile terminal and data on a transaction content inputted in advance into the mobile terminal has been read, a mobile terminal transaction processing unit executes mobile terminal transaction processing in accordance with the transaction content without the aerial display appearing in mid-air.

### CROSS-REFERENCE TO RELATED APPLICATION

This application is a continuation application of International Application PCT/JP2016/054916 filed on Feb. 19, 2016 which designated the U.S., the entire contents of which are incorporated herein by reference.

### FIELD

The embodiments discussed herein are related to an automated transaction apparatus and an automated transaction method, for example an automated transaction apparatus and an automated transaction method that enable transaction operations, such as cash withdrawals, to be performed smoothly without a display for providing operation guidance and making input operations.

### BACKGROUND

Transactions involving financial institutions are typically now performed on automated transaction apparatuses such as Automated Teller Machines (ATMs). Automated transaction apparatuses enable customers to perform transactions like depositing and withdrawing cash via simple operations made using a cash card. In addition to branches of financial institutions, ATMs are installed at remote sites and in convenience stores, making them very accessible to users.

Aside from methods that use cash cards, a method of accessing an ATM using a mobile terminal, such as a smartphone or tablet, owned by the customer is also known (see for example, U.S. Pat. No. 8, 632,000). According to this method, the entire content of a transaction, including a Personal Identification Number (PIN), is inputted in advance into the mobile terminal and is transferred to the automated transaction apparatus by merely holding the mobile terminal up to the automated transaction apparatus. Accordingly, when transaction information for a withdrawal, for example, has been inputted in advance into a mobile terminal, a dispensing operation is performed immediately when the mobile terminal is held up to the automated transaction apparatus.

Transactions performed in this way using a mobile terminal are convenient for the able-bodied, but especially beneficial for the handicapped. Current automated transaction apparatuses are equipped with a handset that is capable of two-way communication with the financial institution, which enables visually impaired users to perform input, operations more easily. In more detail, visually impaired users who are incapable of performing input operations using a touch panel may perform an input operation using buttons on the handset according to audio guidance provided from the handset. Although, this configuration does make it possible to perform an input operation, when a visually impaired user actually uses an automated transaction apparatus, the troublesome way in which data is inputted means that operations often take a long time.

With transaction methods that use a mobile terminal, it is possible to perform the operation of inputting information into the mobile terminal in advance at the customer's own pace. As one example, when a mobile terminal is equipped with a text-to-speech function, it is possible for a visually impaired user to audibly confirm any inputted information and thereby avoid input errors. Accordingly, automated transaction apparatuses that use mobile terminals are expected to become more common due to the ease, reliability, and speed of operations.

This type of automated transaction apparatus is realized by adding a function that enables transactions to be made using a mobile terminal to the function that enables transactions to be made using a cash card. When a transaction is made using a cash card, the transaction commences after the customer has selected a desired transaction in a transaction selection screen which is displayed on a display in response to the customer inserting the cash card into the card slot of the automated transaction apparatus or the customer approaching the automated transaction apparatus. After this, the customer performs an operation in accordance with operation guidance displayed on the display. On the other hand, when a transaction is made using a mobile terminal, an operation is performed by the customer directly holding up the mobile terminal at a predetermined position on the automated transaction apparatus or by selecting a transaction from a transaction selection screen on the display and then holding up the mobile terminal at a predetermined position on the automated transaction apparatus.

For an automated transaction apparatus that is capable of both card transactions using a cash card and mobile terminal transactions using a mobile terminal, the display that is used during card transactions may be redundant during mobile terminal transactions since a mobile terminal itself has a display. Moreover, a customer who is making a mobile terminal transaction may become confused due to the presence of two operation screens. Although this situation may be avoided by having the display of the automated transaction apparatus turned off in a normal state, customers will typically associate the screen being off with the display being broken or with the automated transaction apparatus being out of operation. This means that turning off the display of an automated transaction apparatus to make input operations less confusing may cause greater confusion over whether the automated transaction apparatus is in operation.

### SUMMARY

According to one aspect, there is provided an automated transaction apparatus including: a card insertion detecting unit that detects insertion of a card into a card slot; a card transaction processing unit that executes, in response to the card insertion detecting unit detecting the insertion of the card, transaction processing in accordance with a transaction operation that uses the card; an aerial display that displays guidance for the transaction operation; a display control unit that, causes the aerial display to appear in mid-air in response to the card insertion detecting unit detecting the insertion of the card, that has the guidance for the transaction operation displayed on the aerial display, and that sets the aerial display in a non-display state when the transaction processing by the card transaction processing unit has ended; a mobile terminal detecting unit that detects a mobile terminal into which a transaction content for a transaction has been inputted in advance; and a mobile terminal transaction processing unit that executes transaction processing in accordance with the transaction content stored in the mobile terminal in response to the mobile terminal detecting unit detecting the mobile terminal.

The object and advantages of the invention will be realized and attained by means of the elements and combinations particularly pointed out in the claims.

It is to be understood that both, the foregoing general description and the following detailed description are exemplary and explanatory and are not restrictive of the invention.

### BRIEF DESCRIPTION OF DRAWINGS

FIG. 1 is a functional block diagram of an automated transaction apparatus according to a first embodiment;

FIG. 2 is a flowchart depicting a transaction procedure of the automated transaction apparatus according to the first embodiment;

FIG. 3 is a perspective view depicting an automated transaction apparatus according to a second embodiment when an aerial display is in a non-display state;

FIG. 4 is a perspective view depicting the automated transaction apparatus according to the second embodiment when the aerial display is in a display state;

FIG. 5 depicts an example hardware configuration of the automated transaction apparatus according to the second embodiment;

FIG. 6 is a flowchart depicting a transaction procedure of the automated transaction apparatus according to the second embodiment;

FIG. 7 depicts an example display of an information screen;

FIG. 8 is a flowchart depicting card transaction processing;

FIGS. 9A to 9D depict example screen displays of the aerial display during card transaction processing, where FIG. 9A depicts an example display of a transaction selection screen, FIG. 9B depicts an example display of a PIN input screen, FIG. 9C depicts an example display of a cash amount input screen, and FIG. 9D depicts an example display of a medium returning screen;

FIG. 10 depicts an example display on the display screen of a mobile terminal at the start of a transaction;

FIG. 11 is a flowchart depicting mobile terminal transaction processing;

FIGS. 12A and 12B depict example display screens of the aerial display during a mobile terminal transaction, where FIG. 12A depicts an example display of a PIN input screen and FIG. 12B depicts an example display of a medium returning screen;

FIG. 13 is a flowchart depicting mobile terminal transaction processing according to a third embodiment; and

FIG. 14 depicts an example display of a dispensing guidance display screen during a mobile terminal transaction.

### DESCRIPTION OF EMBODIMENTS

Several embodiments will be described below with reference to the accompanying drawings, wherein like reference numerals refer to like elements throughout. Note that the following embodiments may be implemented in combination as appropriate.

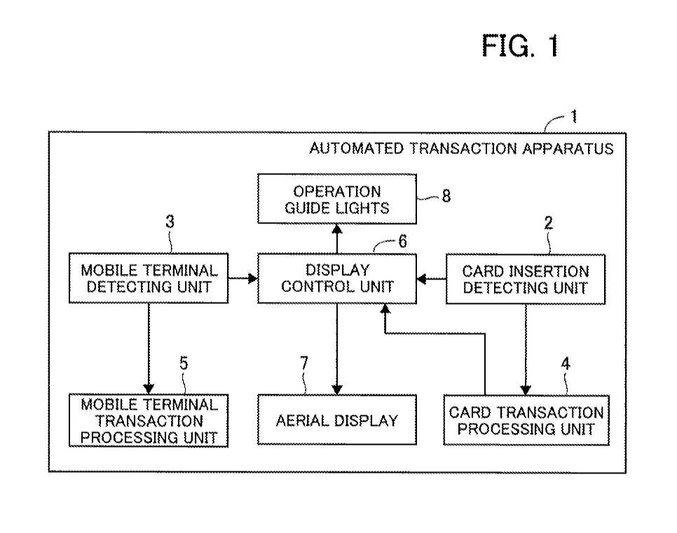

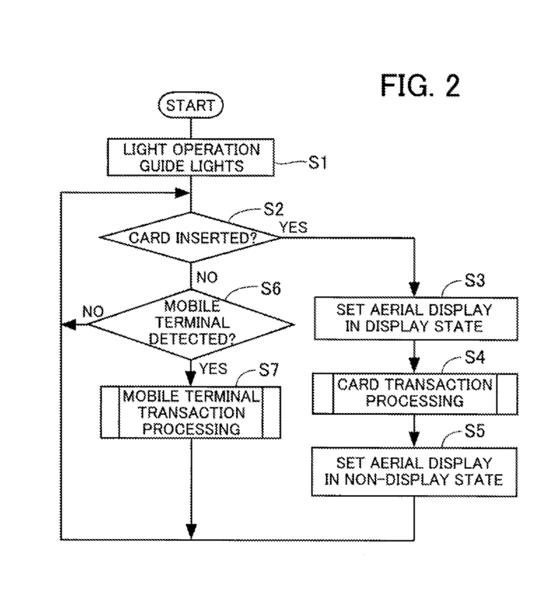

FIG. 1 is a functional block diagram of an automated transaction apparatus according to a first embodiment. FIG. 2 is a flowchart depicting a transaction procedure of the automated transaction apparatus according to the first embodiment.

As depicted in FIG. 1, an automated transaction apparatus 1 according to the first embodiment includes a card insertion detecting unit 2, a mobile terminal detecting unit 3, a card transaction processing unit 4, a mobile terminal transaction processing unit 5, a display control unit 6, an aerial display 7, and operation guide lights 8.

The card insertion detecting unit 2 detects whether a card, such as a cash card or a credit card, has been inserted into a card slot of a card processing unit provided in the automated transaction apparatus 1. When the card insertion detecting unit 2 has detected the insertion of a card, the automated transaction apparatus 1 determines that a card transaction is to be performed.

The mobile terminal detecting unit 3 is realized by a Near Field Communication (NFC) reader provided in the automated transaction apparatus 1 detecting that communication has been established with ah NFC-compatible mobile terminal or by a barcode reader provided in the automated transaction apparatus 1 detecting a barcode displayed on the display of a mobile terminal. As other example methods of detecting a mobile terminal, it is also possible to use a communication means that uses blinking of a mobile screen, a communication means that uses audio, and a wireless communication means that uses Bluetooth (registered trademark) or Wi-Fi (registered trademark). When the mobile terminal detecting unit 3 has detected contactless communication with a mobile terminal or has detected a barcode without contact, the automated transaction apparatus 1 determines that a mobile terminal transaction is to be performed.

When the insertion of a card has been detected by the card insertion detecting unit 2, the card transaction processing unit 4 executes a transaction according to a transaction procedure that uses the card. For a dispensing transaction for example, the card transaction processing unit 4 performs a transaction selection process, an authentication number (hereinafter “PIN”) input process, a withdrawal amount input process, and a process that returns banknotes and the card medium.

When the mobile terminal detecting unit 3 has detected a mobile terminal, the mobile terminal transaction processing unit 5 executes a transaction using the mobile terminal. That is, data to be used in the transaction (or “transaction content”) is inputted in advance into the mobile terminal and when the mobile terminal detecting unit 3 has detected the mobile terminal, the transaction content is read out into the automated transaction apparatus 1, where the mobile terminal transaction processing unit 5 performs transaction processing in accordance with the transaction content.

The display control unit 6 performs control that sets the aerial display 7 in a display state or a non-display state according to whether the card insertion detecting unit 2 has detected the insertion of a card or whether the mobile terminal detecting unit 3 has detected a communication state with a mobile terminal or a barcode. The display control unit 6 also performs illumination control over the operation guide lights 8.

When the aerial display 7 is in the non-display state, there is no display screen, so that the automated transaction apparatus 1 appears to the user to have no display. Conversely, when the aerial display 7 is in the display state, a display screen appears in midair, where a transaction procedure or the like is displayed. At this time, a transaction is performed in accordance with the transaction procedure and the like displayed on the aerial display 7.

The operation guide lights 8 are provided at the card processing unit and at mobile terminal detection regions of the NFC reader and the barcode reader of the automated transaction apparatus 1, and illuminate the card slot of the card processing unit and locations where the NFC reader and the barcode reader are present. By doing so, it becomes easy for the customer to recognize the position where the card is to be inserted and the position where the mobile terminal is to be held up, and possible to guide the customer to the insertion position of the card or the position where the mobile terminal is to be held up.

The above functions of the automated transaction apparatus 1 are realized by a control apparatus, not illustrated, which includes a computer. Next, the operation of the automated transaction apparatus 1 with the above configuration will foe described.

As depicted in FIG. 2, when the automated transaction apparatus 1 starts operating, the display control unit 6 first controls the operation guide lights 8 to light up (or flash) to guide a customer who is positioned facing the automated transaction apparatus 1 to make an initial operation (step S1).

Next, the automated transaction apparatus 1 determines whether the card insertion detecting unit 2 has detected insertion of a card (step S2) and when insertion of a card has been detected (“YES” in step S2), the display control unit 6 sets the aerial display 7 in the display state (step S3). Next, the card transaction processing unit 4 executes card transaction processing (step S4). That is, the customer performs an operation in accordance with the transaction procedure displayed on the aerial display 7. When the card transaction processing ends, the display control unit 6 sets the aerial display 7 in the non-display state (step S5).

When the insertion of a card has not been detected by the card insertion detecting unit 2 in step S2 (“NO” in step S2), the automated transaction apparatus 1 determines whether the mobile terminal detecting unit 3 has detected a mobile terminal (step S6). Here, when the mobile terminal detecting unit 3 has not detected a mobile terminal (“NO” in step S6), the processing returns to step S2.

When the mobile terminal detecting unit 3 has detected a mobile terminal in step S6 (“YES” in step S6), the automated transaction apparatus 1 executes mobile terminal transaction processing using the mobile terminal transaction processing unit 5 in accordance with the transaction content read out by the mobile terminal detecting unit 3 (step S7).

Accordingly, for a card transaction, it is possible to perform transaction processing by having the customer make operations in the same way as before in accordance with operation guidance displayed on the aerial display 7. On the other hand, for a mobile terminal transaction, it is possible to perform transaction processing without the aerial display 7 appearing. As one example, when data that is used in a dispensing transaction has been inputted in advance into a mobile terminal, it is possible to dispense money from the automated transaction apparatus 1 immediately by merely holding up the mobile terminal to the automated transaction apparatus 1.

Also, when guidance, instructions, or the like are to be given to the customer while the mobile terminal transaction processing unit 5 is executing the mobile terminal transaction processing or before or after the mobile terminal transaction processing, it is possible to display the guidance, instructions, or the like using the display of the mobile terminal in place of the aerial display 7. In this case, notifications from the automated transaction apparatus 1 to the mobile terminal are made using an NFC function or the like.

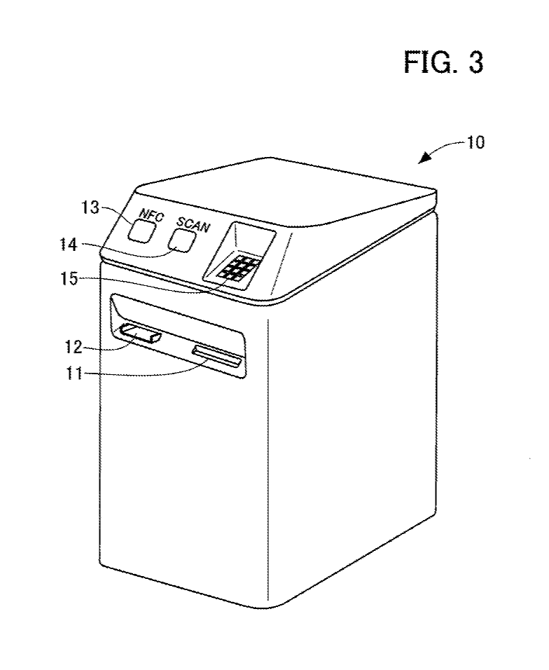

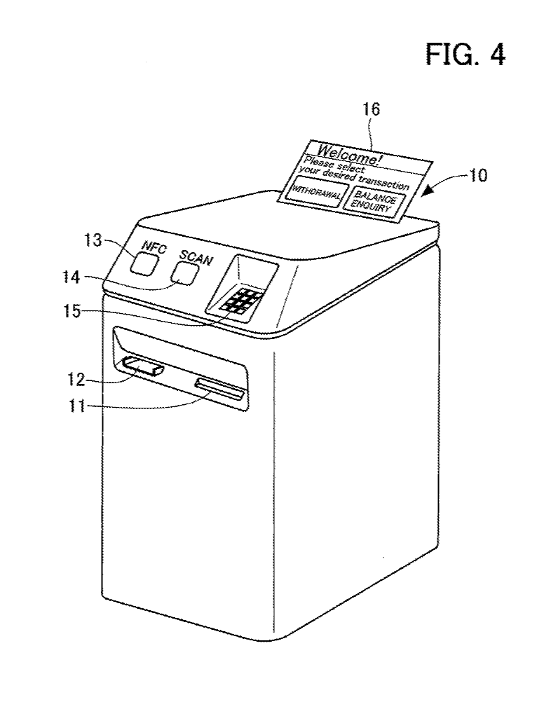

FIG. 3 is a perspective view depicting an automated transaction apparatus according to a second embodiment when an aerial display is in a non-display state. FIG. 4 is a perspective view depicting the automated transaction apparatus according to the second embodiment when the aerial display is in a display state.

An automated transaction apparatus 10 according to the second embodiment includes a card slot 11 and a dispenser port 12 for banknotes on the surface of a case at the front of the automated transaction apparatus 10 that faces the customer. An NFC reader 13, a barcode reader 14, and a ten-key board 15 are provided on an upper portion of the case.

The card slot 11 is a slot into which a card, such as a cash card, is inserted and which discharges the inserted card and a receipt on which transaction details have been printed. An operation guide light is disposed inside the card slot 11, and by lighting up the inside of the slot or the periphery of the slot, it is possible to guide the customer to insert a card when making a card transaction.

The dispenser port 12 is used to dispense banknotes when the transaction is a “withdrawal”.

The NFC reader 13 is used to obtain a transaction content, which has been inputted in advance into a mobile terminal, by using wireless communication when a transaction is to foe performed using a mobile terminal, such as a smartphone. An operation guide light is incorporated into the NFC reader 13 also, and by illuminating a position where the mobile terminal is to be held up and the periphery from inside, it is possible to easily inform the customer of the position where the mobile terminal is to be held up.

The barcode reader 14 optically reads and decodes a barcode, which is displayed on the display of a mobile terminal when a transaction is to be performed using the mobile terminal, using an internal camera. The barcode is produced by encoding a transaction content that has been inputted in advance into the mobile terminal. An operation guide light is incorporated into the barcode reader 14 also, and by illuminating the periphery of a window, where the camera is disposed, from inside, it is possible to easily inform the customer of the position where the mobile terminal is to be held up.

The ten-key board 15 is used for operations such as inputting a PIN and inputting an amount to be dispensed when the transaction is a “withdrawal”.

As depicted in FIG. 4, the automated transaction apparatus 10 also includes an aerial display 16 that appears in mid-air as appropriate.

As the aerial display 16, it is possible to use an optical imaging apparatus that is capable of forming a three-dimensional image in mid-air, such as the apparatus disclosed in International Publication Pamphlet No. WO2009/131128. This optical imaging apparatus is composed of an optical control panel where a planar light reflecting portion is formed inside a transparent flat plate. Light from an object disposed on one side of the plate is used to form an image of the object on the other side of the optical imaging apparatus. That is, an optical imaging apparatus and a display unit such as a liquid crystal display panel are installed inside the automated transaction apparatus 10, and an image displayed on the display unit is formed on an opposite side of the optical imaging apparatus, that is, in a space above the automated transaction apparatus 10. Accordingly, when the display unit is in the non-display state as depicted in FIG. 3, the aerial display 16 does not appear. Conversely, when the display unit is in the display state, as depicted in FIG. 4, the aerial display 16 appears and displays the images displayed by the display unit.

Although not illustrated, the automated transaction apparatus 10 further includes an input operation detecting unit that detects touches on buttons displayed on the aerial display 16. As the input operation detecting unit, it is possible for example to use an infrared sensor that detects the customer's fingers, with the infrared sensor being incorporated inside the automated transaction apparatus 10 at a position that corresponds to the position where the aerial display 16 appears. This infrared sensor detects touches on buttons displayed in mid-air by detecting whether fingers are present at specified coordinates in the space where the aerial display 16 is being displayed.

Also, although not illustrated, the automated transaction apparatus 10 includes a customer sensor that detects when a customer has approached the automated transaction apparatus 10. As the customer sensor, it is possible to use an infrared sensor, which as one example is installed inside, the automated transaction apparatus 10 in the periphery of the NFC reader 13.

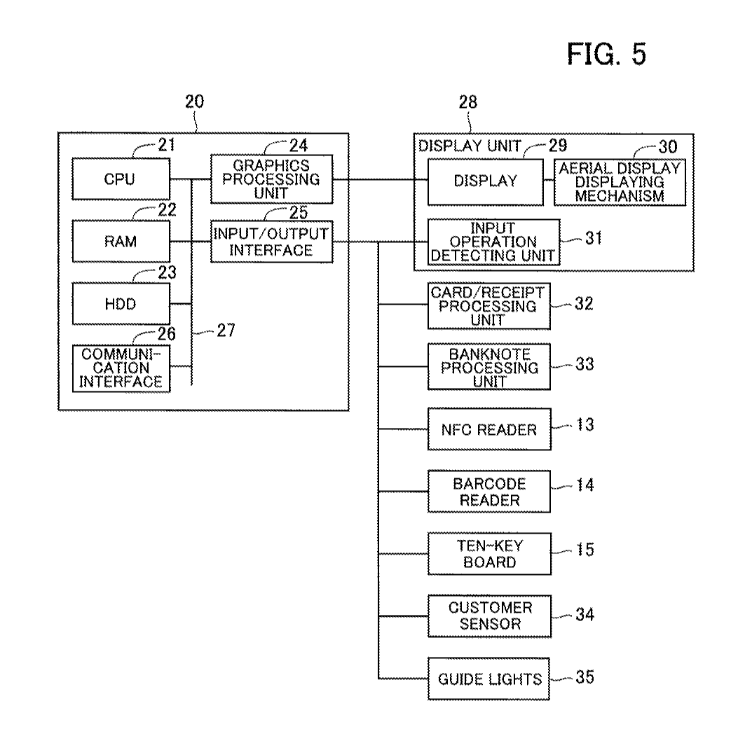

FIG. 5 depicts an example hardware configuration of the automated transaction apparatus according to the second embodiment. The automated transaction apparatus 10 is composed of a computer (control unit) 20 including a Central Processing Unit (CPU) 21 and a Random Access Memory (RAM) 22 as main functions, with the automated transaction apparatus 10 as a whole being controlled by the CPU 21. The CPU 21 is connected to the RAM 22 and a plurality of peripherals via a bus 27.

The RAM 22 is used as a main storage apparatus of the computer 20. The RAM 22 temporarily stores at least part of an Operating System (OS) program and an application program to be executed by the CPU 21. Various data used in processing by the CPU 21 is also stored in the RAM 22.

The peripherals connected to the bus 27 include a Hard Disk Drive (HDD) 23, a graphics processing unit 24, an input/output interface 25, and a communication interface 26.

The HDD 23 performs magnetic reads and writes of data onto and from internally housed disks. The HDD 23 is used as a secondary storage apparatus of the computer. OS programs, application programs, and various data are stored in the HDD 23. Note that as the secondary storage apparatus, it is also possible to use a semiconductor storage apparatus such as flash memory.

The graphics processing unit 24 is connected to a display 29 of a display unit 28. The graphics processing unit 24 displays images on the screen of the display 29 in accordance with instructions from the CPU 21. The display 29 is related to an aerial display displaying mechanism 30, such as the image forming apparatus described above, and is used to construct the aerial display 16.

The input/output interface 25 is connected to an input operation detecting unit 31 of the display unit 28. The input operation detecting unit 31 is the infrared sensor for detecting the customer's fingers mentioned above. The input/output interface 25 transmits signals detected by the input operation detecting unit 31 to the CPU 21.

The input/output interface 25 is also connected to a card/receipt processing unit 32, a banknote processing unit 33, the NFC reader 13, the barcode reader 14, the ten-key board 15, a customer sensor 34, and guide lights 35.

The card/receipt processing unit 32 reads information from a card inserted into the card slot 11 and transmits the information via the input/output interface 25 to the CPU 21. The card/receipt processing unit 32 also includes a receipt printer, prints information on the details of a transaction received via the input/output interface 25 from the CPU 21, and discharges a printed receipt together with the card when the card is discharged from the card slot 11.

The banknote processing unit 33 includes a banknote storage box, a banknote distinguishing unit and a banknote conveying unit. When a dispensing instruction has been received via the input/output interface 25 from the CPU 21 for example, the banknote processing unit 33 performs a process that takes an indicated number of banknotes of the indicated denominations from the banknote storage box and discharges the banknotes from the dispenser port 12.

When a mobile terminal has approached the automated transaction apparatus 10, the NFC reader 13 establishes communication with the mobile terminal. When data relating to a transaction has been inputted in advance into the mobile terminal, the NFC reader 13 obtains the data relating to the transaction and transmits the data via the input/output interface 25 to the CPU 21. The NFC reader 13 is also capable of transmitting information received via the input/output interface 25 from the CPU 21 to the mobile terminal to have the information displayed on the display of the mobile terminal.

When a mobile terminal has been held up, the barcode reader 14 reads a barcode displayed on the display of the mobile terminal. The barcode is produced by encoding data relating to a transaction that was inputted in advance into the mobile terminal. On reading the barcode, the barcode reader 14 transmits the obtained data via the input/output interface 25 to the CPU 21.

The ten-key board 15 is used to input a PIN and to input a cash amount for a dispensing transaction. Data on the PIN or cash amount inputted using the ten-key board 15 is transmitted via the input/output interface 25 to the CPU 21.

The customer sensor 34 detects whether a customer has approached the automated transaction apparatus 10 and, on detecting the presence of a customer, transmits detection data via the input/output interface 25 to the CPU 21.

The guide lights 35 are installed at the card slot 11, the NFC reader 13, the barcode reader 14, and the like and are controlled so as to light up (or flash) in accordance with instructions from the CPU 21 that are received via the input/output interface 25. The guide lights 35 may also be installed at the dispenser port 12, the ten-key board 15, and/or at other parts.

The communication interface 26 is connected via a network to a host computer of a financial institution. The communication interface 26 transmits and receives data to and from other computers via the network.

By using the hardware configuration described above, it is possible to realize the processing functions of the automated, transaction apparatus 10 according to the second embodiment.

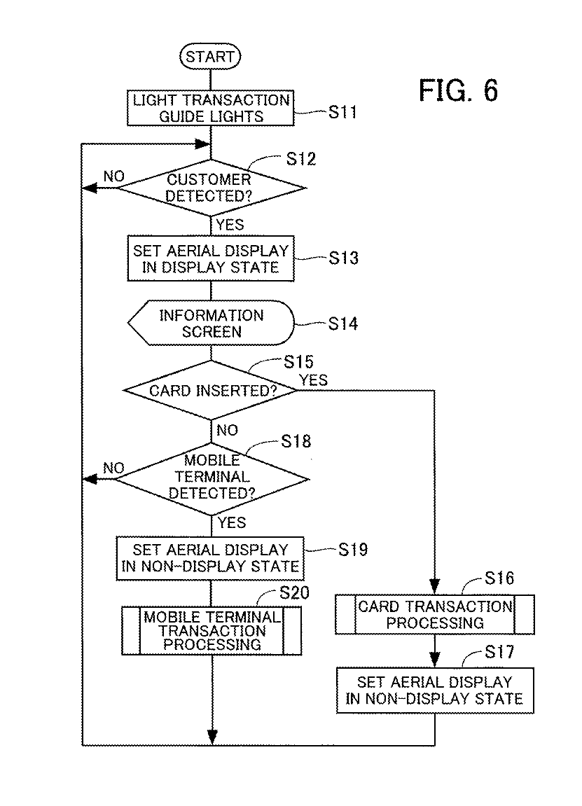

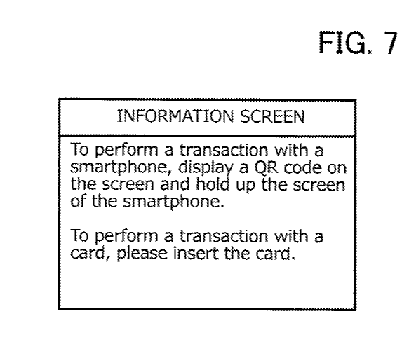

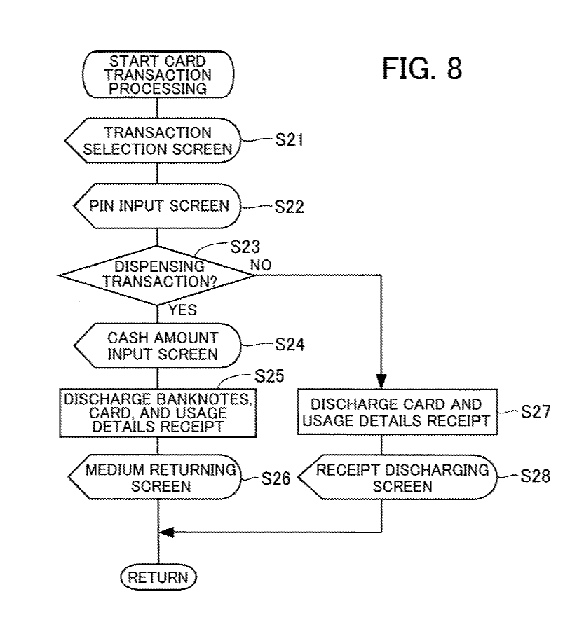

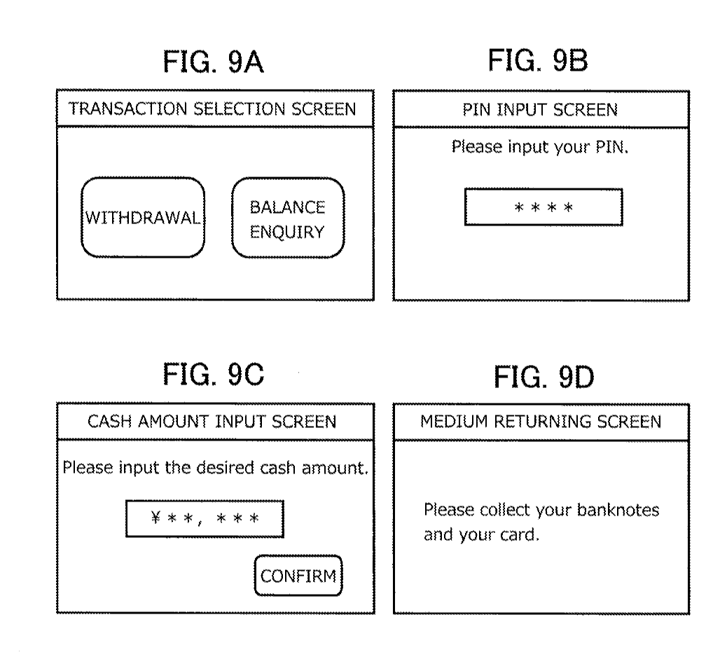

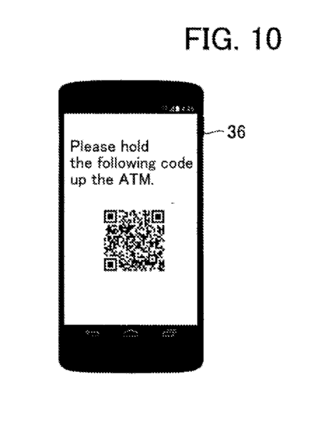

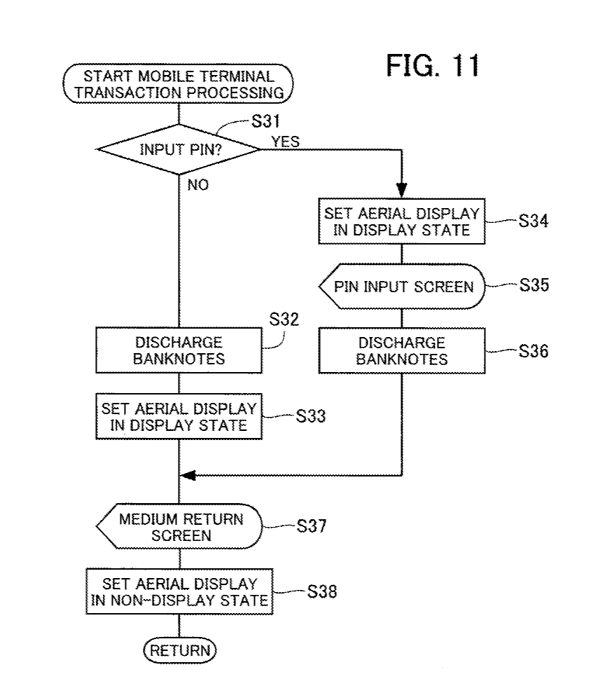

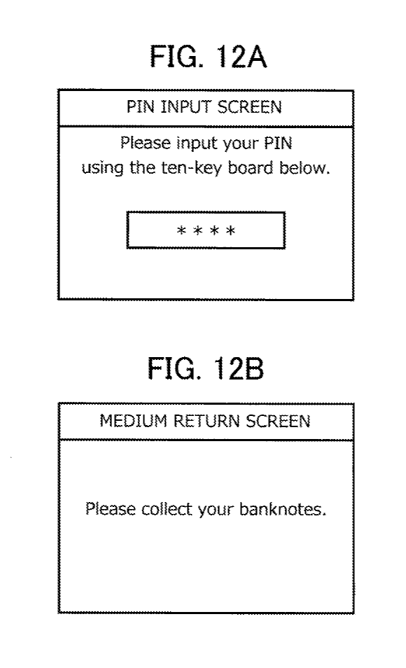

FIG. 6 is a flowchart depicting a transaction procedure of the automated transaction apparatus according to the second embodiment. FIG. 7 depicts an example display of an information screen. FIG. 8 is a flowchart depicting card transaction processing. FIGS. 9A to 9D depict example screen displays of the aerial display during card transaction processing. FIG. 9A depicts an example display of a transaction selection screen. FIG. 9B depicts an example display of a PIN input screen. FIG. 9C depicts an example display of a cash amount input screen. FIG. 9D depicts an example display of a medium returning screen. FIG. 10 depicts an example display on the display screen of a mobile terminal at the start of a transaction. FIG. 11 is a flowchart depicting mobile terminal transaction processing. FIGS. 12A and 12B depict example display screens of the aerial display during a mobile terminal transaction. FIG. 12A depicts an example display of a PIN input screen. FIG. 12B depicts an example display of a medium returning screen.

As depicted in FIG. 6, when the automated transaction apparatus 10 according to the second embodiment starts the transaction processing, the CPU 21 first lights the guide lights 35 (step S11) to notify the customer of candidates for an operation to be performed first (a card insertion operation or a holding-up operation of a mobile terminal).

Next, the CPU 21 determines whether the customer sensor 34 has detected a customer (step S12) and when a customer has not been detected, the detection of a customer is awaited (“NO” in step S12). When a customer has been detected (“Yes” in step S12), the CPU 21 has the aerial display 16 displayed (step S13). At this time, the CPU 21 has an information screen displayed on the aerial display 16 (step S14). As depicted in FIG. 7, the information screen provides guidance on the operation method to both a customer who wants to perform a transaction using a mobile terminal (smartphone) and a customer who wants to perform a transaction using a card.

Next, the CPU 21 determines whether notification of the detection of insertion of a card has been received from the card/receipt processing unit 32 (step S15). When the insertion of a card has been detected (“YES” in step S15), the CPU 21 advances the processing to the card transaction processing (step S16) and when the card transaction processing has been completed, sets the aerial display 16 in the non-display state (step S17) and advances the processing to step S12.

When it is determined in step S15 that, insertion of a card has not been detected (“NO” in step S15), the CPU 21 determines whether notification of detection of a mobile terminal has been received from the NFC reader 13 or the barcode reader 14 (step S18). When notification of the detection of a mobile terminal has not been received (“NO” in step S18), the CPU 21 advances the processing to step S12. When notification of the detection of a mobile terminal has been received by the CPU 21 from the NFC reader 13 or the barcode reader 14 as a result of the customer holding up a mobile terminal into which a transaction content has been inputted in advance to the NFC reader 13 or the barcode reader 14 (“YES” in step S18), the CPU 21 sets the aerial display 16 in a non-display state (step S19) and advances the processing to the mobile terminal transaction processing (step S20). When the mobile terminal transaction processing has been completed, the CPU 21 advances the processing to step S12.

As depicted in FIG. 8, in the card transaction processing in step S16, the CPU 21 switches the display of the aerial display 16 from the information screen to the transaction selection screen (step S21). As one example, in the display depicted in FIG. 9A, this transaction selection screen displays selection buttons labeled “WITHDRAWAL” and “BALANCE INQUIRY”.

Next, on receiving notification of the selection of one of the selection buttons from the input operation detecting unit 31, the CPU 21 switches the display of the aerial display 16 from the transaction selection screen to the PIN input screen (step S22). By doing so, as depicted in FIG. 9B for example, the aerial display 16 displays guidance for inputting a PIN and a box for displaying a number inputted from the ten-key board 15.

After this, the CPU 21 determines whether the transaction selected in the transaction selection screen is a dispensing transaction (step S23) and when the transaction is a dispensing transaction (“YES” in step S23), switches the display of the aerial display 16 from the PIN input screen to the cash amount input screen (step S24). As one example, in the example display depicted in FIG. 9C, the cash amount input screen displays guidance for inputting the cash amount the customer wishes to withdraw, a box for displaying a number inputted via the ten-key board 15, and a confirm button.

Next, when notification of an input operation of the confirm button has been received from the input operation detecting unit 31, the CPU 21 instructs the banknote processing unit 33 to perform dispensing processing to discharge the banknotes and instructs the card/receipt processing unit 32 to perform card discharge to return the card medium (step S25).

Next, the CPU 21 switches the display of the aerial display 16 from the cash amount input screen to the medium returning screen (step S26). As one example, in the example display depicted in FIG. 9D, the medium returning screen displays guidance that provides a warning to stop the customer from leaving behind the banknotes, discharged from the dispenser port 12 and the card discharged from the card slot 11. At this time, a receipt on which details of the transaction have been printed is discharged from the card slot 11 together with the card by the card/receipt processing unit 32. After this, the CPU 21 returns the processing to the flow in FIG. 6.

When, in step S23, the transaction selected in the transaction selection screen is not a dispensing transaction (“NO” in step S23) , the CPU 21 instructs the card/receipt processing unit 32 to return the card and print and discharge a receipt with balance information (step S27).

The CPU 21 then switches the display of the aerial display 16 from the PIN input screen to a receipt discharging screen (step S28). After this, the CPU 21 returns the processing to the flow in FIG. 6.

Next, a mobile terminal transaction will be described. When a customer has been detected in step S12 in FIG. 6, the CPU 21 displays the aerial display 16 and gives guidance for a mobile terminal transaction in an information screen depicted in FIG. 7. When a customer wishes to perform a mobile terminal transaction, the customer will be in possession of a mobile terminal in which a transaction content has been inputted in advance to produce a transaction ready state. As depicted in FIG. 10, in the transaction ready state, a mobile terminal 36 displays operation guidance for a mobile terminal transaction and a barcode, which has been produced by encoding data related to a dispensing transaction that has been inputted in advance, on the display screen of the mobile terminal 36. In the illustrated example, the barcode is displayed using a QR code (registered trademark) that is a two-dimensional barcode.

When the mobile terminal 36 has been held up to the NFC reader 13 and has established communication with the NFC reader 13, the CPU 21 determines in step S18 in FIG. 6 that the mobile terminal 36 has been detected. Alternatively, when a barcode displayed by the mobile terminal 36 has been held up to the barcode reader 14 and the barcode has been read by the barcode reader 14, the CPU 21 determines in step S18 in FIG. 6 that, the mobile terminal 36 has been detected (“YES” in step S18). When the mobile terminal 36 has been detected, the aerial display 16 is set in the non-display state in step S19 and the mobile terminal transaction processing is commenced in step S20.

As depicted in FIG. 11, the mobile terminal transaction processing starts with the CPU 21 determining whether a PIN is to be manually inputted (step S31). Since the data inputted in advance into the mobile terminal 36 normally includes data on the PIN, this data is used, eliminating the need of inputting a PIN (“NO” in step S31). Here, the CPU 21 instructs the banknote processing unit 33 to perform dispensing processing to discharge banknotes (step S32) and sets the aerial display 16 in the display state (step S33).

In step S31, when the automated transaction apparatus 10 as been set so that a PIN is inputted using the ten-key board 15 even for a mobile terminal transaction (“YES” in step S31), the CPU 21 sets the aerial display 16 in the display state (step S34) and switches the screen to the PIN input screen (step S35). As depicted in FIG. 12A, the PIN input screen displays input guidance for a PIN and a box for displaying a number that has been inputted via the ten-key board 15. When a PIN has been inputted in accordance with the input guidance for a PIN and authenticated, the CPU 21 instructs the banknote processing unit 33 to perform the dispensing processing to discharge banknotes (step S36).

After this, the CPU 21 sets the display screen of the aerial display 16 at the medium returning screen (step S37). As one example, as depicted in FIG. 12B, the medium returning screen displays guidance that provides a warning to stop the customer from leaving behind the banknotes discharged from the dispenser port 12. On detecting the banknotes have been removed from the dispenser port 12, the CPU 21 sets the aerial display 16 in the non-display state (step S38) and returns the processing to the flow to FIG. 6. Note that when the CPU 21 has determined that the mobile terminal 36 has not been detected within a predetermined time in step S18 in FIG. 6 (“NO” in step S18), the processing returns to step S12.

In this way, in the second embodiment, in the mobile terminal transaction processing, aside from when the inputting of a PIN is to be performed, a display screen is displayed on the aerial display 16 only when displaying the medium returning screen. This means that the aerial display 16 is set in the display state only during a transaction, which means that it is possible to reduce the display time of the display 29 that constructs the aerial display 16 and thereby increase the lifespan of the display 29 (in particular, expendable parts such as the light source).

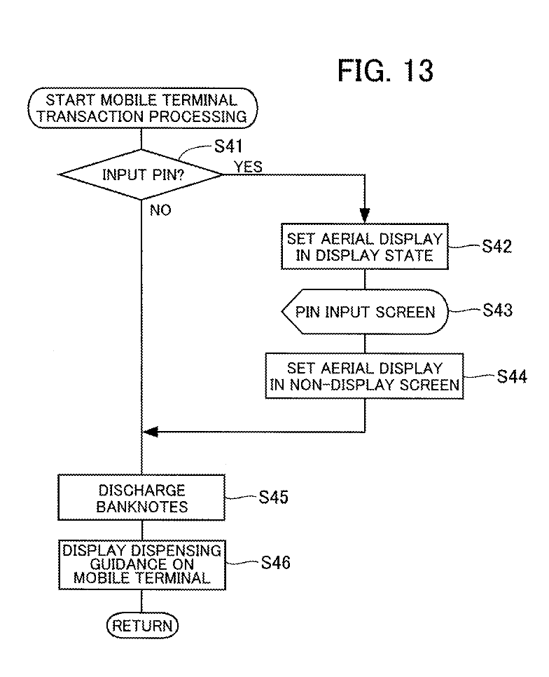

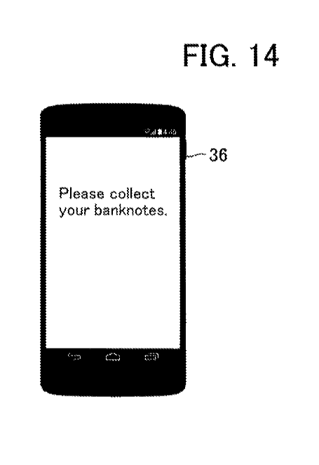

FIG. 13 is a flowchart, depicting mobile terminal transaction processing according to a third embodiment. FIG. 14 depicts an example display of a dispensing guidance display screen during a mobile terminal transaction. In this third embodiment, a flowchart depicting the overall operation and a flowchart depicting the card transaction processing are the same as the flowcharts depicted in FIGS. 6 and 8 described in the second embodiment, and for this reason, only the flowchart for the mobile terminal transaction processing is described below.

As depicted in FIG. 13, in the mobile terminal transaction processing in the third embodiment, the CPU 21 first determines whether a PIN is to be inputted (step S41). Here, when the automated transaction apparatus 10 has been set so that a PIN is inputted using the ten-key board 15 even for a mobile terminal transaction (“YES” in step S41), the CPU 21 sets the aerial, display 16 in the display state (step S42) and has a PIN input screen displayed (step S43). Here, when a PIN has been inputted in accordance with input guidance for a PIN and authenticated, the CPU 21 sets the aerial display 16 in the non-display state (step S44).

When the determination in step S41 finds that a PIN is not to be inputted (“NO” in step S41) or the aerial display 16 has been set in the non-display state in step S44, the CPU 21 instructs the banknote processing unit 33 to perform the dispensing processing to discharge banknotes (step S45).

After this, the CPU 21 instructs the mobile terminal 36 to display dispensing guidance (step S46) and returns the processing to the flow in FIG. 6. As one example, as depicted in FIG. 14, the displaying of dispensing guidance at the mobile terminal 36 is achieved using the display of the mobile terminal 36.

In this way, in the mobile terminal transaction processing in the third embodiment, aside from when a PIN is to be inputted, the aerial display 16 is not displayed. This means that the aerial display 16 effectively only appears when the information screen to be displayed in step S14 in FIG. 6 is displayed.

Note that although a dispensing transaction has been described as one example in the embodiments described above, when a depositing transaction is performed, it is fundamentally possible to perform the transaction as a mobile terminal transaction without using the aerial display. This is because confirmation of the monetary amount of banknotes that have been inserted may be performed using the display screen of the mobile terminal 36. Note that the timings given above for setting the aerial display in the display state and the non-display state are mere examples to which the present embodiments are not limited. The timing at which the aerial display may be displayed or not displayed may be set as appropriate.

The automated transaction apparatus and automated transaction method of the configurations described above use an aerial display that has images appear in mid-air when appropriate and do not use a component that a customer would recognize as a display. This is advantageous in reliably avoiding customer confusion during operations.

All examples and conditional language provided herein are intended for the pedagogical purposes of aiding the reader in understanding the invention and the concepts contributed by the inventor to further the art, and are not to foe construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An automated transaction apparatus comprising:
a card insertion detecting unit that detects insertion of a card into a card slot;
a card transaction processing unit that executes, in response to the card insertion detecting unit detecting the insertion of the card, transaction processing in accordance with a transaction operation that uses the card;
an aerial display that displays guidance for the transaction operation;
a display control unit that causes the aerial display to appear in mid-air in response to the card insertion detecting unit detecting the insertion of the card, that has the guidance for the transaction operation displayed on the aerial display, and that sets the aerial display in a non-display state when the transaction processing by the card transaction processing unit has ended;
a mobile terminal detecting unit that detects a mobile terminal into which a transaction content for a transaction has been inputted in advance; and
a mobile terminal transaction processing unit that executes transaction processing in accordance with the transaction content stored in the mobile terminal in response to the mobile terminal detecting unit detecting the mobile terminal.

2. The automated transaction apparatus according to claim 1,
further comprising operation guide lights that are respectively provided at the card slot and a region where the mobile terminal is detected and that use light to guide an operation to insert the card and an operation to hold up a mobile terminal.

3. The automated transaction apparatus according to claim 1,
further comprising a customer sensor that detects a customer who has approached,
wherein in response to the customer sensor detecting that the customer has approached, the display control unit causes the aerial display to appear in mid-air and has operation guidance for a card transaction and a mobile terminal transaction displayed on the aerial display.

4. The automated transaction apparatus according to claim 1,
wherein when an authentication number is to be inputted during execution by the mobile terminal transaction processing unit of the transaction processing that uses the mobile terminal, the display control unit causes the aerial display to appear in mid-air and has guidance for an input operation of the authentication number displayed.

5. The automated transaction apparatus according to claim 1,
wherein when guidance is to be displayed during execution of the transaction processing that uses the mobile terminal, the mobile terminal transaction processing unit instructs the mobile terminal to display the guidance on a display of the mobile terminal.

6. The automated transaction apparatus according to claim 1,
wherein the mobile terminal detecting unit is a wireless communication means for fetching the transaction content inputted in advance into the mobile terminal using wireless communication.

7. The automated transaction apparatus according to claim 1,
wherein the aerial display includes:
an internal display that is provided inside the automated transaction apparatus and displays an image to be displayed in mid-air; and
an aerial, display displaying mechanism that forms the image displayed on the internal display outside the automated transaction apparatus.

8. The automated transaction apparatus according to claim 7,
wherein the aerial display includes an input operation detecting unit that is provided inside the automated transaction apparatus and that detects a touch operation on the image displayed in mid-air by detecting whether a finger is present at specified coordinates in the image formed in mid-air.

9. The automated transaction apparatus according to claim 3,
wherein the display control unit sets the aerial display in the non-display state when the mobile terminal detecting unit has detected the mobile terminal.

10. The automated transaction apparatus according to claim 4,
wherein the display control unit sets the aerial display in the non-display state when the input operation of the authentication number has ended during execution by the mobile terminal transaction processing unit of the transaction processing that uses the mobile terminal.

11. The automated transaction apparatus according to claim 6,
wherein, the wireless communication means is at least one of a near-field communication reader that obtains information using wireless communication and a barcode reader that optically reads a barcode produced by encoding the transaction content.

12. An automated transaction method that causes a computer to perform a procedure comprising:
displaying a transaction operation on an aerial display, where an image is formed in mid-air, in response to detection of insertion of a card into a card slot and executing transaction processing in accordance with the displayed transaction operation;
reading a transaction content, that has been inputted in advance into a mobile terminal, in response to detection of the mobile terminal being held up and executing transaction processing in accordance with the transaction content; and
setting the aerial display in a non-display state when the aerial display is being displayed at an end of a transaction.
